(19) United States
(12) Patent Application Publication
(10) Pub. No.: US 2021/0390574 A1
(43) Pub. Date: Dec. 16, 2021

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Kei TAKEMURA, Tokyo (JP); Shinji ITO, Tokyo (JP)

(73) Assignee: NEC Corporation, Minato-ku, Tokyo (JP)

(21) Appl. No.: 17/258,590

(22) PCT Filed: Jul. 12, 2018
(86) PCT No.: PCT/JP2018/026273

§ 371 Date: Jan. 7, 2021

(51) Int. Cl. G06Q 30/02

(52) U.S. Cl. CPC G06Q 30/0226

(57) ABSTRACT

Provided is an information processing system including: a condition acquisition unit that acquires constraint information on an action and candidate information for each of a plurality of candidates targeted for the action; a reward function estimation unit that estimates a reward function used for calculating a reward in accordance with the action for each of the plurality of candidates based on the constraint information and the candidate information; and an action determination unit that determines a content of the action based on the reward function for each of the plurality of candidates.

### TECHNICAL FIELD

The present invention relates to an information processing system, an information processing method, and a storage medium.

### BACKGROUND ART

Non-Patent Literature 1 discloses a scheme that can be used for determination of a content to be recommended to a user on an online application such as a distribution site of movies or the like. Non-Patent Literature 1 proposes a recommendation system that recommends a plurality of movies to a user by using an algorithm based on contextual (with context) combinatorial bandit, which is a type of multi-arm bandit issues.

### CITATION LIST

### Non Patent Literature

NPL 1: L. Qin, S. Chen, and X. Zhu, “Contextual Combinatorial Bandit and its Application on Diversified Online Recommendation”, in Proceedings of the 2014 SIAM International Conference on Data Mining, pp. 461-469, 2014.

### SUMMARY OF INVENTION

### Technical Problem

In the recommendation system disclosed in Non-Patent Literature 1, there is no consideration on feedback of a movie which has not been recommended to the user. In such a way, in the conventional decision making scheme, there may be no consideration on a candidate that is not targeted, and suitable decision making may be unable to be realized for some constraint conditions of issues.

The present invention has been made in view of the problem described above, and the example object thereof is to provide an information processing system, an information processing method, and a storage medium that may realize suitable decision making even for more general constraint conditions.

### Solution to Problem

According to one example aspect of the present invention, provided is an information processing system including: a condition acquisition unit that acquires constraint information on an action and candidate information for each of a plurality of candidates targeted for the action; a reward function estimation unit that estimates a reward function used for calculating a reward in accordance with the action for each of the plurality of candidates based on the constraint information and the candidate information; and an action determination unit that determines a content of the action based on the reward function for each of the plurality of candidates.

According to another example aspect of the present invention, provided is an information processing method including: acquiring constraint information on an action and candidate information for each of a plurality of candidates targeted for the action; estimating a reward function used for calculating a reward in accordance with the action for each of the plurality of candidates based on the constraint information and the candidate information; and determining a content of the action based on the reward function for each of the plurality of candidates.

According to another example aspect of the present invention, provided is a storage medium storing a program that causes a computer to perform an information processing method including: acquiring constraint information on an action and candidate information for each of a plurality of candidates targeted for the action; estimating a reward function used for calculating a reward in accordance with the action for each of the plurality of candidates based on the constraint information and the candidate information; and determining a content of the action based on the reward function for each of the plurality of candidates.

### Advantageous Effects of Invention

According to the present invention, it is possible to provide an information processing system, an information processing method, and a storage medium that may realize suitable decision making even for more general constraint conditions.

### BRIEF DESCRIPTION OF DRAWINGS

FIG. 1 is a block diagram illustrating a hardware configuration example of an information processing system according to a first example embodiment.

FIG. 2 is a function block diagram illustrating a configuration example of the information processing system according to the first example embodiment.

FIG. 3 is a flowchart illustrating the operation of the information processing system according to the first example embodiment.

FIG. 4 is a table illustrating an example of candidate information according to the first example embodiment.

FIG. 5 is a table illustrating rewards in Application example 1 of the first example embodiment.

FIG. 6 is a table illustrating purchase probabilities in Application example 2 of the first example embodiment.

FIG. 7 is a table illustrating expected values of rewards in Application example 2 of the first example embodiment.

FIG. 8 is a graph illustrating the relationship between estimated rewards and the number of trials in Application example 2 of the first example embodiment.

FIG. 9 is a function block diagram illustrating a configuration example of an information processing system according to a second example embodiment.

### DESCRIPTION OF EMBODIMENTS

The example embodiments of the present invention will be described below with reference to the drawings. Note that, in the drawings described below, components having the same function or corresponding functions are labeled with the same references, and the repeated description thereof may be omitted.

### First Example Embodiment

Before description of the specific configuration of the present example embodiment, technical matters and examples of applied scenes that are assumptions on which the present example embodiment is based will be described. An information processing system of the present example embodiment is a system that performs information processing for decision making such as a way of allocation of measures such as promotions (sales promotion activity such as distribution of an advertisement). Herein, allocation of promotions refers to determination as to which user the promotion is to be provided and which user the promotion is not to be provided, for example. Further, allocation of promotions may be referred to as an action in a more general sense. Further, the user may be referred to as a candidate in a more general sense. The content of a promotion is not particularly limited and may be, for example, an online advertisement displayed on a browser, an advertisement through an electronic mail, a direct mail, sending of a discount ticket, or the like.

There are various algorithms that perform decision making by using a reward function. In the actual scene of decision making, however, it may be difficult to obtain, in advance and in a full state, a reward function used for predicting a reward (for example, a purchase price, a purchase probability, an expected value of a purchase price, or the like) to an action (for example, allocation of a promotion). For example, in a phase where there is no information, it is difficult to predict a probability at which a user targeted for a promotion or a user not targeted for a promotion purchases a product. Further, even when there is some information, such a probability may often include an error. Thus, there is a need for repeatedly executing an action determined based on a reward function and acquiring the result thereof to enhance estimation accuracy of the reward function and increase a reward actually obtained in the course thereof as much as possible.

The multi-arm bandit issue is one of the models that may be applied to a scene where such successive decision making is requested. When there are a plurality of slot machines for which the likelihood of winning is unable to be known in advance, the multi-arm bandit issue may be an issue as to how the player maximizes a reward in repeatedly selecting and trying any one of the slot machines (pulling the arm).

In the multi-arm bandit issue, there has been study of an algorithm to maximize a total reward taking into consideration of a tradeoff between “searching” to search for a slot machine that is likely to be won by the player and “utilizing” to select and try the slot machine that is likely to be won by the player to ensure a reward. Further, the multi-arm bandit issue can be applied to other uses than a slot machine, and application to various decision making has been studied. An approach in accordance with the multi-arm bandit issue can be applied to the allocation issue of a promotion described above by replacing selection of a slot machine with selection of a targeted user for the promotion.

In the example of the slot machine, a slot machine whose arm is not pulled neither operates nor obtains a reward. That is, the fact that the player is able to obtain only the information on a reward of a slot machine whose arm was actually pulled is an assumption of a setting of an issue. The example of Non-Patent Literature 1 is under the same assumption. When the multi-arm bandit issue is applied to an actual issue that is different from the slot machine, however, information on rewards of not only a selected choice but also a not-selected choice may be obtained for some types of issues.

For example, in the example of promotions described above, not only a user provided with a promotion but also a user not provided with a promotion may purchase a product, and information on a purchase history thereof or the like is obtained. In such an example, information on the reward of a not-selected choice has to be considered.

The information processing system of the present example embodiment uses an algorithm adapted to the multi-arm bandit issue, however, may realize suitable decision making for more general constraint conditions. In the following, the configuration of the information processing system of the present example embodiment will be described along with specific instances.

The information processing system of the present example embodiment is a system for determining how to allocate a promotion made for selling a product to a plurality of pre-registered users. For example, when the promotion is a direct mail, the present information processing system may be a system that determines which user of the registered users the direct mail is to be sent. In this example, the direct mail may be unable to be sent to all the users because of too many users or the like, and the number of direct mails that can be sent to is a constraint condition of allocation of promotions. Note that the information processing system of the present example embodiment and the system used for providing promotion to users based on determined allocation may be integrally formed or may be separately formed.

Further, the information processing system of the present example embodiment is based on an assumption that purchase information (whether or not a product has been purchased or the like) can be acquired from both a user provided with a promotion and a user not provided with a promotion. Note that the information processing system of the present example embodiment and the system used for acquiring purchase information may be integrally formed or may be separately formed.

In the following description, unless otherwise specified, the number of types of promotions is one, and a measure that may be performed on each user is either to provide the promotion or not to provide the promotion. However, the number of types of promotions may be plural.

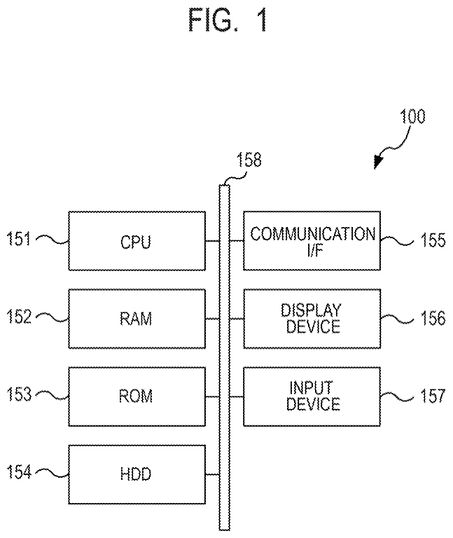

FIG. 1 is a block diagram illustrating a hardware configuration example of an information processing system 100. The information processing system 100 may be, for example, a computer such as a server, a desk top personal computer (PC), a note PC, a tablet PC, or the like.

The information processing system 100 has a central processing unit (CPU) 151, a random access memory (RAM) 152, a read only memory (ROM) 153, and a hard disk drive (HDD) 154, as a computer that performs calculation, control, and storage. Further, the information processing system 100 has a communication interface (I/F) 155, a display device 156, and an input device 157. The CPU 151, the RAM 152, the ROM 153, the HDD 154, the communication I/F 155, the display device 156, and the input device 157 are connected to each other via a bus 158. Note that the display device 156 and the input device 157 may be connected to the bus 158 via a drive device (not illustrated) used for driving these devices.

Although FIG. 1 illustrates the components forming the information processing system 100 being as an integrated device, some of the functions thereof may be provided by an external device. For example, the display device 156 and the input device 157 may be an external device that are different from a section forming the function of the computer including the CPU 151 and the like.

The CPU 151 is a processor that performs a predetermined operation in accordance with a program stored in the ROM 153, the HDD 154, or the like and also has a function of controlling each component of the information processing system 100. The RAM 152 is formed of a volatile storage medium and provides a temporary memory region required for the operation of the CPU 151. The ROM 153 is formed of a nonvolatile storage medium and stores information required for a program or the like used for the operation of the information processing system 100. The HDD 154 is a storage device that is formed of a nonvolatile storage medium and stores data required for processing, a program used for the operation of the information processing system 100, or the like.

The communication I/F 155 is a communication interface based on a specification such as the Ethernet (registered trademark), Wi-Fi (registered trademark), 4G, or the like, which is a module used for communicating with other devices. The display device 156 is a liquid crystal display, an organic light emitting diode (OLED) display, or the like and is used for display of an image, a text, an interface, or the like. The input device 157 is a keyboard, a pointing device, or the like and is used by a user to operate the information processing system 100. An example of the pointing device may be a mouse, a trackball, a touch panel, a pen tablet, or the like. The display device 156 and the input device 157 may be integrally formed as a touch panel.

Note that the hardware configuration illustrated in FIG. 1 is illustrated as an example, a device other than the above may be added, and some of the devices may not be provided. Further, some of the devices may be replaced with another device having the same function. Furthermore, some of the functions of the present example embodiment may be provided by another device via a network, and the function of the present example embodiment may be distributed to and implemented in a plurality of devices. For example, the HDD 154 may be replaced with a solid state drive (SSD) using a semiconductor memory or may be replaced with cloud storage.

Further, the information processing system 100 may include a graphics processing unit (GPU), an application specific integrated circuit (ASIC), a field programmable gate array (FPGA), or the like. The function of control and calculation in the information processing system 100 may be implemented not only by the CPU but also by a GPU, an ASIC, an FPGA, or the like.

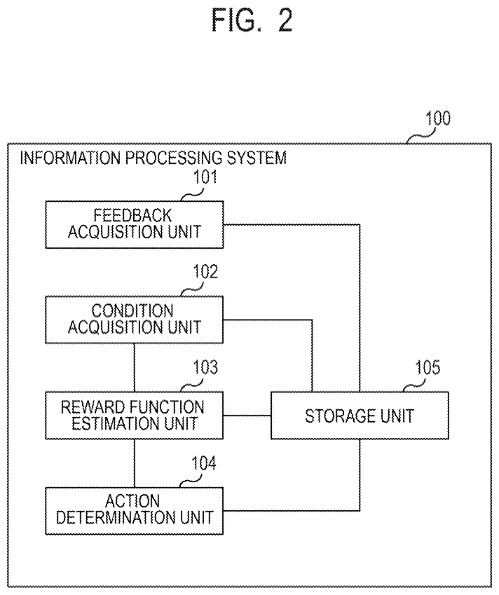

FIG. 2 is a function block diagram of the information processing system 100. The information processing system 100 has a feedback acquisition unit 101, a condition acquisition unit 102, a reward function estimation unit 103, an action determination unit 104, and a storage unit 105. The CPU 151 implements the functions of the reward function estimation unit 103 and the action determination unit 104 by loading a program stored in the ROM 153, the HDD 154, or the like into the RAM 152 and executing the program. The CPU 151 implements the function of the feedback acquisition unit 101, the condition acquisition unit 102, and the storage unit 105 by controlling the HDD 154, the communication I/F 155, or the like based on a program. The process performed by these units will be described later.

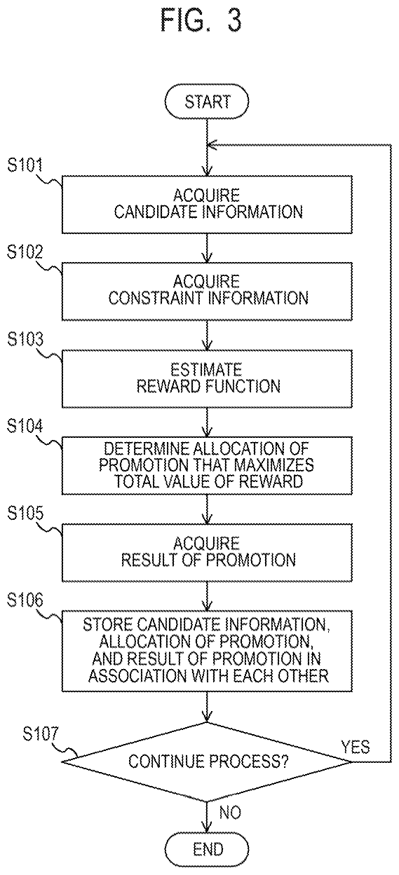

FIG. 3 is a flowchart illustrating a process performed by the information processing system 100 according to the present example embodiment. The process performed by the information processing system 100 will be described with reference to FIG. 3.

The information processing system 100 of the present example embodiment is a system that performs information processing for successive decision making. The information processing system 100 repeatedly performs determination of a content of a promotion to be provided to the user and acquisition of a result of the promotion by repeating the process from step S101 to step S106.

In step S101, the condition acquisition unit 102 acquires candidate information on each of users that are candidates who may be targeted for a promotion. This candidate information may include information such as the number of users, information on past purchase made by the user, whether or not a promotion has been provided in the past, whether or not the product has been purchased in the past, the attribute of the user, or the like, for example.

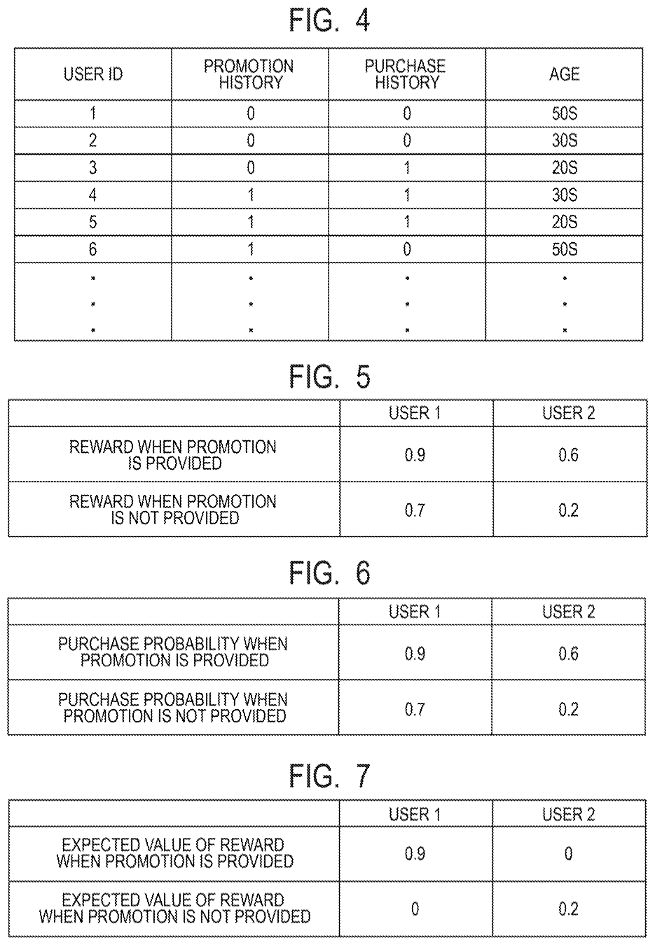

FIG. 4 is a table illustrating an example of candidate information. FIG. 4 illustrates the user identifier (ID), the promotion history, the purchase history, and the age of users. The promotion history indicates the number of times that the promotion was provided in the past. The purchase history indicates the number of times that the product was purchased in the past. The age is an example of the attribute of the user. Note that the numbers of times in the promotion history and the purchase history being included as numerical values in the candidate information is mere example, and this may be replaced with information on the presence or absence of the promotion history and the purchase history.

The promotion history and the purchase history may be used for a reward function. The attribute of the user, such as the age, may be used as information on a feature amount in a contextual bandit algorithm by the information processing system 100 of the present example embodiment.

In step S102, the condition acquisition unit 102 acquires constraint information on the promotion. This constraint information is information related to a constraint condition for a method of providing the promotion and may be, for example, the upper limit of the number of users to which the promotion can be provided, the type of promotion when multiple types of promotions are provided, or the like. Note that the process of step S101 and step S102 may be performed in the reverse order or may be performed in parallel.

The acquisition process performed by the condition acquisition unit 102 may be to read candidate information acquired in advance from the storage unit 105. Further, the acquisition process performed by the condition acquisition unit 102 may be to accept entry from an operator or may be to acquire candidate information via a network. Further, when candidate information and constraint information are acquired from the outside of the information processing system 100, the storage unit 105 newly stores the candidate information and the constraint information or stores the candidate information and the constraint information in a manner to update the existing information.

In step S103, the reward function estimation unit 103 estimates a reward function used for calculating a reward in accordance with the promotion for each of the plurality of users based on the constraint information and the candidate information. The reward function is given so as to be able to calculate different values for respective users, as illustrated in Equation (1). The index i of a reward Rᵢ, a reward function rᵢ, and the like is a value such as a user ID or the like and distinguishes the users. Note that the number of users is n in the example of Equation (1). Further, the coefficient x denotes a value corresponding to a choice for allocation of the promotion (action) to all the users, and in other words, the coefficient x includes information on allocation to all the users. For example, the value of the coefficient x may be a setting such that the value is 1 for a case of a way of allocation to provide a promotion to a user 1 but not to provide the promotion to the remaining users. In such a way, the reward function estimation unit 103 can calculate, on a user basis, rewards obtained when allocation of various promotions is performed. Note that the coefficient x may be a scalar or may be a vector.

[Math. 1]

R₁=r₁(x); R₂=r₂(x); . . . ; Rₙ=rₙ(x) (1)

In step S104, the action determination unit 104 determines allocation of the promotion based on the reward function of each of the plurality of users as illustrated in Equation (1). Specifically, as illustrated in Equation (2), a total value Rₛᵤₘ of rewards is calculated by summing the reward functions rᵢ corresponding to respective users, and x is determined so as to maximize the total value Rₛᵤₘ of rewards. The allocation of a promotion that may be determined herein may be such allocation that is to provide a promotion to the user 1 but not to provide the promotion to the remaining users, for example. Note that maximization of the total value Rₛᵤₘ of rewards is an example, and x may be determined so that the function used for evaluation including the reward function rᵢ satisfies a predetermined condition.

$$[ Math . 2 ]$$

$${R}_{sum} = {\sum }_{k = 1}^{n} {r}_{k} ( x ) \qquad ( 2 )$$

The allocation of the promotion determined in step S104 is output to a promotion-providing system or the like outside the information processing system 100 and utilized for providing an actual promotion.

In step S105, the feedback acquisition unit 101 acquires a result of the promotion as feedback for allocation of the promotion determined in step S104.

In step S106, the feedback acquisition unit 101 stores the acquired result of the promotion in the storage unit 105 in association with the candidate information used in the promotion and the allocation of the promotion. Accordingly, the candidate information stored in the storage unit 105 is updated to candidate information in which the current promotion is taken into consideration. Further, the result of the promotion may be used for a calculation equation for a reward in a reward function. In such a way, learning using a feedback result is automatically performed.

In step S107, the CPU 151 of the information processing system 100 determines whether or not to continue the present process. This determination may be to determine whether or not a predetermined number of loop times is reached, may be to determine whether or not the operator of the information processing system 100 performs an operation to stop the process, or may be to determine whether or not a predetermined stop condition is satisfied. If it is determined to continue the process, the process proceeds to step S101 (step S107, YES). If it is not determined to continue the process, the present process ends (step S107, NO).

As described above, in the information processing system 100 of the present example embodiment, estimation of a reward function is performed so that calculation of a reward in accordance with an action for each of a plurality of candidates (users that may be targeted for a promotion) can be performed. Since the action is allocation of a promotion in this example, a reward of not only “a case of providing a promotion” but also “a case of not providing a promotion” can be calculated for a particular user. In such a way, in the present example embodiment, since calculation of a reward can be performed in more general constraint conditions, the information processing system 100 that may realize suitable decision making even for more general constraint conditions is realized.

Further, in this example, an action is determined so as to maximize the total value of rewards obtained by summing reward functions corresponding to respective users. Accordingly, in this example, since allocation of a promotion is determined by summing rewards for both the cases of “a user to which a promotion is provided” and “a user to which the promotion is not provided”, decision making in which the reward of “a user to which the promotion is not provided” is also taken into consideration is realized. As described above, in this example, the information processing system 100 that may realize more suitable decision making is realized.

An application example applied to a specific issue using the information processing system 100 of the present example embodiment will be described. Note that the following application example is provided for more clearly describing the configuration and the advantageous effect of the present example embodiment and is not intended for limited interpretation of the applied scope of the information processing system 100 of the present example embodiment.

### Application Example 1

In Application example 1, to clearly describe the advantageous effect of the present example embodiment, an application example of the present example embodiment applied to a simplified model will be described. First, the assumption condition of Application example 1 will be described. The users that may be targeted for a promotion are only two users of a user 1 and a user 2. Further, the type of the promotion is only one type. Furthermore, the number of promotions that can be provided being only any one of the user 1 and the user 2 is a constraint condition of the promotion. That is, an action that may be taken (constraint information on the action) is any of two types of “providing the promotion to the user 1 but not providing the promotion to the user 2” and “not providing the promotion to the user 1 but providing the promotion to the user 2”.

For the user 1 and the user 2, the purchase price of a product changes for each of a case where a promotion is provided and a case where no promotion is provided. Such a purchase price of the product is a reward in this application example. FIG. 5 is a table illustrating rewards of the user 1 and the user 2. Further, it can be said that the table of FIG. 5 is a reward function used for calculating a reward in accordance with an action. As illustrated in FIG. 5, the reward of the user 1 is 0.9 when a promotion is provided and 0.7 when no promotion is provided. The reward of the user 2 is 0.6 when a promotion is provided and 0.2 when no promotion is provided. For example, the total reward of the user 1 and the user 2 when the promotion is provided to the user 1 but the promotion is not provided to the user 2 is 0.9+0.2=1.1.

The information processing system 100 of the present example embodiment repeats determination of an action (providing of a promotion to the user 1 or the user 2) and observation of a result (acquisition of purchase information as to whether or not the user 1 and the user 2 purchased a product) by performing the process of FIG. 3. The purpose of this Application example 1 is to maximize the total reward obtained from the user 1 and the user 2 while repeating the determination of an action and the observation of a result described above. Needless to say, the reward described in the table of FIG. 5 is unknown in the initial state. Thus, the information processing system 100 performs estimation of a reward function in the course of repeating the process of FIG. 3.

In the issue setting described above, the information processing system 100 of the present example embodiment can take into consideration of both a reward obtained when a promotion is provided and a reward obtained when no promotion is provided and determines an action so as to maximize the total reward of the user 1 and the user 2. Accordingly, as learning of the reward function proceeds, the information processing system 100 provides the promotion to the user 2 without providing the promotion to the user 1. Accordingly, the total reward (per one action) is 0.7+0.6=1.3, and an action to maximize the reward in the assumption condition of Application example 1 is realized.

On the other hand, if the algorithm in which a reward from a not-selected candidate is not taken into consideration as with Non-Patent Literature 1 is applied to the issue of Application example 1, an action is selected so that the reward of a user provided with a promotion is maximized. Specifically, in comparison between the user 1 and the user 2, since the reward when the promotion is provided is larger for the user 1, selection such that the promotion is provided to the user 1 but the promotion is not provided to the user 2 is continued. The total reward (per one action) of this case is 0.9+0.2=1.1, and an action that maximizes the reward is not realized.

As can be understood from Application example 1 described above, the information processing system 100 of the present example embodiment realizes more suitable decision making by taking the reward of a user not provided with a promotion into consideration to perform determination of an action.

Note that the optimization instance of Application example 1 with the information processing system 100 teaches that it is optimal to provide a promotion to the user 2 having a large difference of rewards between a case where the promotion is not provided and a case where the promotion is provided. This corresponds to a marketing rule of thumb that it is effective to find a prospective customer who has not frequently purchased a product so far and provide a promotion thereto. In such a way, the information processing system 100 is already able to obtain a reasonable conclusion by the learning using feedback for a result of an action.

### Application Example 2

A method of setting a more suitable reward function when a reward is given in a probabilistic manner in which a part of the issue of Application example 1 is changed will be described as Application example 2.

In Application example 2, it is assumed that the user 1 and the user 2 purchase a product at a particular probability in a case where a promotion is provided and a case where no promotion is provided, respectively. FIG. 6 is a table illustrating the product purchase probability for the user 1 and the user 2. As illustrated in FIG. 6, the product purchase probability for the user 1 is 0.9 when the promotion is provided and 0.7 when the promotion is not provided. The product purchase probability for the user 2 is 0.6 when the promotion is provided and 0.2 when the promotion is not provided.

Further, the reward when the user purchases a product is 1, and the reward when the user does not purchase a product is 0. Therefore, the expected value of the reward due to purchase of the product by the user 1 when the promotion is provided to the user 1 is 1*0.9+0*(1−0.9)=0.9. Therefore, the expected value of the reward matches the value of the purchase probability indicated in FIG. 6. The same applies to other values in FIG. 5. Therefore, the values in the table indicated in FIG. 6 is also expected values of the reward and can be said as a reward function.

Even when a reward is given in a probabilistic manner in such a way, it is desirable that the same conclusion as that in Application example 1 be obtained by maximizing the expected value of the reward. When a reward is given in a probabilistic manner, however, estimation of a reward function may not be performed suitably. An example of such a case will be described below.

It is assumed that the first action is to provide a promotion to only the user 1 and the second action is to provide a promotion to only the user 2. At this time, if the result of the first action is that the user 1 purchased the product but the user 2 did not purchase the product, the reward of the user 1 is 1, and the reward of the user 2 is 0. Further, if the result of the second action is that neither the user 1 nor the user 2 purchased the product, both the rewards of the user 1 and the user 2 are 0. If these results are directly interpreted, this leads to a conclusion that it is better to provide the promotion to the user 1 than to the user 2. If this result is directly fed back, it is determined that it is optimal to continue to provide the promotion to only the user 1 in the subsequent actions.

In this situation, if the action of providing the promotion to the user 1 but not providing the promotion to the user 2 is repeated to proceed with learning of the reward function, the reward function as illustrated in FIG. 7 is obtained. FIG. 7 is a table illustrating a reward function after learning of the user 1 and the user 2. As illustrated in FIG. 7, the expected value of the reward of the user 1 when the promotion is provided and the expected value of the reward of the user 2 when the promotion is not provided are suitable values. However, expected values of other rewards are 0 and thus are not suitable values. This is because no action to provide the promotion to only the user 2 is performed after the results of the first and second actions are obtained and thereby the learning is completed in a result of the reward being 0.

Selection of providing the promotion to the user 1 but not providing the promotion to the user 2 is continued based on the table of FIG. 7 even after the completion of learning. Since the total reward (per one action) in such a case is 0.9+0.2=1.1, an action to maximize the reward may not be realized.

To solve this problem, it is preferable to optimistically estimate a reward function by correcting the reward function. Herein, the expression “optimistic” means highly estimating a reward of an uncertain choice and, more specifically, adding a large correction value to a reward function for a user whose reward function is uncertain due to a small number of times of providing a promotion. Accordingly, the promotion is more likely to be provided to a user whose reward function is uncertain, and the likelihood of the unsuitable learning being performed as described above can be reduced.

As an example of an estimation method for an optimistic reward function, the overview of the optimistic reward function based on Upper Confidence Bound (UCB) and a result of a simulation will be described. In this scheme, an optimistically estimated reward of a particular action “a” (allocation of a particular promotion) to a particular user u is set by Equation (3) below.

(optimistically estimated reward)=(estimated reward)+(reliability of estimation) (3)

The estimated reward of Equation 3 is expressed by Equation (4) below.

$$[ Math . 3 ]$$

$$\frac{{R}_{total}}{{t}_{⊥} + λ} \qquad ( 4 )$$

The reliability of estimation of Equation 3 is expressed by Equation (5) below.

$$[ Math . 4 ]$$

$$( \sqrt{d log ( \frac{1 + ( Nt \text{/} λ )}{δ} )} + \sqrt{λ} S ) \text{/} {t}_{1} \qquad ( 5 )$$

Herein, the value Rₜₒₜₐₗ is the sum of rewards caused by the action “a” to the user u. For example, if a reward of 1 occurs for 10 times due to the action “a” to the user u, the Rₜₒₜₐₗ is 10.

The value t₁ is the number of times that the action “a” to the user u is performed. The value λ is a value determined by the number of users and the constraint condition and is 2 in this example. The value d is the dimension of vectors of users. The vectors of users are to express respective users by vectors that are linearly independent from each other, such as (1, 0) for the user 1 and (0, 1) for the user 2. Therefore, the dimension of the vectors of users is two in this example. The value N is a value determined by the constraint condition and is 2 in this example.

The value t is the number of trials (the number of times that allocation of a promotion is performed and the result thereof is observed). It can be said in another way that the value t is a sum of the number of times that the action “a” to the user u is performed and the number of times that the action “a” to the user u is not performed. The symbol “/” of Equation 5 denotes a fraction, and p/q is a value obtained by dividing p by q. The value δ is a parameter related to a probability at which an algorithm is successful and is 0.001 in this example. The value S is a value determined by the level of an obtained reward and the dimension of the vector of users and is 2 in this example.

As illustrated in Equation 5, the reliability of estimation is an increasing function with respect to t and gradually increases as the process is repeated and the number of trials increases. On the other hand, the reliability of estimation is also a decreasing function with respect to t₁ and decreases when the action “a” is performed on the user u. Therefore, the optimistically estimated reward gradually increases when a trial in which the action “a” is not performed on the user u is continued and decreases when the action “a” is performed on the user u. That is, the reliability of estimation is a parameter used for highly estimating (optimistically estimating) the reward of an action “a” which has been tried less and correcting the reward so that such an action “a” is more likely to be selected.

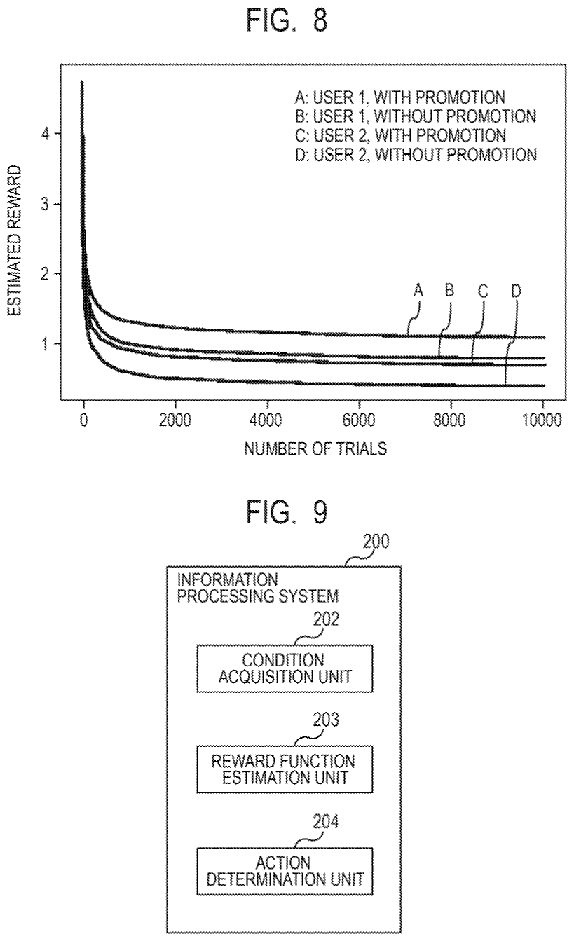

Next, a simulation result of an optimistically estimated reward will be described. FIG. 8 is a graph illustrating the relationship between the estimated reward calculated by the scheme described above and the number of trials. FIG. 8 illustrates a result obtained by simulating how the estimated reward changes as the number of trials increases for four conditions classified by the distinction of the user 1 and the user 2 and the presence or absence of the promotion. As illustrated in FIG. 8, the estimated reward is a much larger value than the expected value of the reward due to the item of the estimated reliability while the number of trials is small. However, it is found that the estimated reward gradually converges toward the expected value of the reward as the number of trials increases.

In such a way, with application of an optimistic reward function based on the UCB, estimation of a reward function is suitably performed even when the reward is probabilistically given.

### Application Example 3

Another approach to the issue when a reward is probabilistically given as described in Application example 2 will be described as Application example 3. In Application example 3, determination of an action (determination of allocation of a promotion) is performed by using Thompson sampling. The Thompson sampling is a scheme to generate a random number in accordance with a posterior probability distribution (for example, a beta distribution) of expected values for respective actions and execute an action (having the largest random value, for example) by using the generated random number as an evaluation index. According to this scheme, an action is selected so that the posterior probability of the particular action being the optimal and the execution probability of the action are matched. In this scheme, since an action other than an action determined to be optimal at a particular point of time is also often executed at a probability in accordance with the posterior probability distribution, the likelihood of unsuitable learning as described in Application example 2 being performed can be reduced.

It is empirically known that the likelihood of selecting the optimal action is higher with the Thompson sampling than with the UCB. Therefore, the scheme of Application example 3 may be more effective than the scheme of Application example 2.

Note that, as yet another approach, an algorithm called ε-greedy may be used for the information processing system 100 of the present example embodiment. The ε-greedy is to execute an action estimated as the optimal at a point of time of a probability (1−ε) based on a random number and execute another action at a probability ε. Also when this scheme is used, the likelihood of unsuitable learning as described in Application example 2 being performed can be reduced.

The information processing system described in the above example embodiment can be configured as with the following second example embodiment.

### Second Example Embodiment

FIG. 9 is a function block diagram illustrating a configuration example of an information processing system 200 according to the present example embodiment. The information processing system 200 has a condition acquisition unit 202, a reward function estimation unit 203, and an action determination unit 204. The condition acquisition unit 202 acquires constraint information on an action and candidate information for each of a plurality of candidates targeted for the action. The reward function estimation unit 203 estimates a reward function used for calculating a reward in accordance with the action for each of the plurality of candidates based on the constraint information and the candidate information. The action determination unit 204 determines a content of the action based on the reward function for each of the plurality of candidates.

According to the present example embodiment, the information processing system 200 that may realize suitable decision making even for more general constraint conditions is provided.

### Modified Example Embodiment

Although the present invention has been described above with reference to the example embodiments, the present invention is not limited to the example embodiments described above. Various modifications that may be understood by those skilled in the art can be made to the configuration and details of the present application invention within the scope not departing from the spirit of the present invention.

The information processing system in the example embodiments described above is used in decision making for suitably performing allocation of a promotion to be provided to the user. As already described, however, “user” can be generalized to “candidate”, and “allocation of a promotion” can be generalized to “action”. That is, the information processing system in the example embodiments described above is applicable to other uses than allocation of a promotion.

For example, the information processing system in the example embodiments described above can be used for a use to perform allocation of work to a person in charge in order to improve operation efficiency. In such a case, the information processing system in the example embodiments described above is applicable by replacing “person in charge” with “candidate” and replacing “allocation of work” with “action”.

Further, the information processing system in the example embodiments described above can be used for a use to perform allocation of calculation to a computer in order to reduce calculation cost. In such a case, the information processing system in the example embodiments described above is applicable by replacing “computer” with “candidate” and replacing “allocation of calculation” with “action”.

Further, the information processing system in the example embodiments described above can be used for a use to optimize allocation of a passage route of a vehicle in order to reduce transportation cost. In such a case, the information processing system in the example embodiments described above is applicable by replacing “vehicle” with “candidate” and replacing “allocation of a passage route” with “action”.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself. Further, one or two or more components included in the example embodiments described above may be a circuit such as an ASIC, an FPGA, or the like configured to implement the function of each component.

As the storage medium, for example, a floppy (registered trademark) disk, a hard disk, an optical disk, a magneto-optical disk, a compact disc-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

Further, a service implemented by the function of each of the example embodiments described above may be provided to a user in a form of Software as a Service (SaaS).

The whole or part of the example embodiments disclosed above can be described as, but not limited to, the following supplementary notes.

(Supplementary Note 1)

An information processing system comprising:

a condition acquisition unit that acquires constraint information on an action and candidate information for each of a plurality of candidates targeted for the action;

a reward function estimation unit that estimates a reward function used for calculating a reward in accordance with the action for each of the plurality of candidates based on the constraint information and the candidate information; and

an action determination unit that determines a content of the action based on the reward function for each of the plurality of candidates.

(Supplementary Note 2)

The information processing system according to supplementary note 1, wherein the action includes selecting at least one of the plurality of candidates as a target for a measure and not targeting a candidate other than the selected candidate for the measure.

(Supplementary Note 3)

The information processing system according to supplementary note 2, wherein the reward function is configured to calculate a reward obtained when a corresponding candidate is targeted for the measure and a reward obtained when the corresponding candidate is not targeted for the measure.

(Supplementary Note 4)

The information processing system according to any one of supplementary notes 1 to 3, wherein the reward function includes a function that changes based on a result of the action.

(Supplementary Note 5)

The information processing system according to supplementary note 4, wherein the reward function includes a function that changes in accordance with the number of times that the action was performed in the past.

(Supplementary Note 6)

The information processing system according to supplementary note 4 or 5, wherein the reward function includes a function that changes in accordance with the number of times that a corresponding candidate was targeted for a measure included in the action.

(Supplementary Note 7)

The information processing system according to supplementary note 5 or 6, wherein the reward function includes a function based on Upper Confidence Bound (UCB).

(Supplementary Note 8)

The information processing system according to any one of supplementary notes 4 to 7, wherein the reward function includes a random number.

(Supplementary Note 9)

The information processing system according to any one of supplementary notes 4 to 8, wherein the reward function includes a random number based on Thompson sampling.

(Supplementary Note 10)

The information processing system according to any one of supplementary notes 4 to 9, wherein the candidate information includes information indicating whether or not a corresponding candidate has been targeted for a measure included in the action.

(Supplementary Note 11)

The information processing system according to any one of supplementary notes 4 to 10, wherein the candidate information includes information indicating a result of the action.

(Supplementary Note 12)

The information processing system according to any one of supplementary notes 1 to 11, wherein the action determination unit determines a content of the action so that a sum of respective rewards of the plurality of candidates is maximized based on the reward function.

(Supplementary Note 13)

The information processing system according to any one of supplementary notes 1 to 12,

wherein the action includes allocation of a promotion, and

wherein the candidates are users to which the promotion is provided.

(Supplementary Note 14)

An information processing method comprising:

acquiring constraint information on an action and candidate information for each of a plurality of candidates targeted for the action;

estimating a reward function used for calculating a reward in accordance with the action for each of the plurality of candidates based on the constraint information and the candidate information; and

determining a content of the action based on the reward function for each of the plurality of candidates.

(Supplementary Note 15)

A storage medium storing a program that causes a computer to perform an information processing method comprising:

acquiring constraint information on an action and candidate information for each of a plurality of candidates targeted for the action;

estimating a reward function used for calculating a reward in accordance with the action for each of the plurality of candidates based on the constraint information and the candidate information; and

determining a content of the action based on the reward function for each of the plurality of candidates.

### REFERENCE SIGNS LIST

100, 200 information processing system
101 feedback acquisition unit
102, 202 condition acquisition unit
103, 203 reward function estimation unit
104, 204 action determination unit
105 storage unit
151 CPU
152 RAM
153 ROM
154 HDD
155 communication I/F
156 display device
157 input device
158 bus

What is claimed is:

1. An information processing system comprising:
a condition acquisition unit that acquires constraint information on an action and candidate information for each of a plurality of candidates targeted for the action;
a reward function estimation unit that estimates a reward function used for calculating a reward in accordance with the action for each of the plurality of candidates based on the constraint information and the candidate information; and
an action determination unit that determines a content of the action based on the reward function for each of the plurality of candidates.

2. The information processing system according to claim 1, wherein the action includes selecting at least one of the plurality of candidates as a target for a measure and not targeting a candidate other than the selected candidate for the measure.

3. The information processing system according to claim 2, wherein the reward function is configured to calculate a reward obtained when a corresponding candidate is targeted for the measure and a reward obtained when the corresponding candidate is not targeted for the measure.

4. The information processing system according to claim 1, wherein the reward function includes a function that changes based on a result of the action.

5. The information processing system according to claim 4, wherein the reward function includes a function that changes in accordance with the number of times that the action was performed in the past.

6. The information processing system according to claim 4, wherein the reward function includes a function that changes in accordance with the number of times that a corresponding candidate was targeted for a measure included in the action.

7. The information processing system according to claim 5, wherein the reward function includes a function based on Upper Confidence Bound (UCB).

8. The information processing system according to claim 4, wherein the reward function includes a random number.

9. The information processing system according to claim 4, wherein the reward function includes a random number based on Thompson sampling.

10. The information processing system according to claim 4, wherein the candidate information includes information indicating whether or not a corresponding candidate has been targeted for a measure included in the action.

11. The information processing system according claim 4, wherein the candidate information includes information indicating a result of the action.

12. The information processing system according to claim 1, wherein the action determination unit determines a content of the action so that a sum of respective rewards of the plurality of candidates is maximized based on the reward function.

13. The information processing system according to claim 1,
wherein the action includes allocation of a promotion, and
wherein the candidates are users to which the promotion is provided.

14. An information processing method comprising:
acquiring constraint information on an action and candidate information for each of a plurality of candidates targeted for the action;
estimating a reward function used for calculating a reward in accordance with the action for each of the plurality of candidates based on the constraint information and the candidate information; and
determining a content of the action based on the reward function for each of the plurality of candidates.

15. A non-transitory storage medium storing a program that causes a computer to perform an information processing method comprising:
acquiring constraint information on an action and candidate information for each of a plurality of candidates targeted for the action;
estimating a reward function used for calculating a reward in accordance with the action for each of the plurality of candidates based on the constraint information and the candidate information; and
determining a content of the action based on the reward function for each of the plurality of candidates.
